(19) United States
(12) Patent Application Publication
(10) Pub. No.: US 2007/0108348 A1
(43) Pub. Date: May 17, 2007

(54) System for safeguarding dangerous substances, such as fuels, in tank reservoirs

(76) Inventor: Peer Peters, Munster (DE)

Correspondence Address: MH2 TECHNOLOGY LAW GROUP, 1951 KIDWELL DRIVE, SUITE 550, TYSONS CORNER, VA, 22182, US

(21) Appl. No.: 10/556,059

(22) PCT Filed: May 10, 2004
(86) PCT No.: PCT/EP04/50741

§ 371 Date: Feb. 2, 2007

(30) Foreign Application Priority Data
May 9, 2003 (DE) 103 21 002.4

(51) Int. Cl. B64D 37/02; F02B 61/04; B60R 21/00

(52) U.S. Cl. 244/135 R; 180/271; 180/69.5; 440/88 F; 220/88.3; 137/209

(57) ABSTRACT

The invention relates to a system for safeguarding dangerous substances, such as fuels, in tank reservoirs, having a tank reservoir and a feed unit, which is connected to the tank reservoir and inside of which substances that bind dangerous substances are located and can be transferred into the tank reservoir. The tank reservoir and feed unit are connected to one another in such a manner and the substances that bind dangerous substances are selected in such a way that, when transferring the substances, the dangerous substance inside the tank reservoir can be physically retained in the substances, in particular, by absorption. If, at the same time, the dangerous substance inside the tank reservoir can be transferred by means of a chemical reaction into a chemically modified state that prevents the ignition thereof by increasing the flash point, the discharging of the dangerous substance from the tank reservoir and the ignition thereof are prevented in a very effective manner.

The invention relates to a system for safeguarding dangerous substances, such as propellant fuels, in tank reservoirs.

In the field of safeguarding dangerous substances, it is known (DE-C 1 088 876), by charging the power fuel reservoir with inert gases, to neutralize potentially dangerous liquids, for example liquid hydrocarbons, which are situated in power fuel reservoirs of aircraft or ships. This, firstly, prevents the fire and explosion risk, and secondly creates an overpressure with respect to ambient pressure, in the respective power fuel reservoir.

It is a disadvantage in this case that, although the inert gases suppress the ignition hazard in an undamaged reservoir, they do not prevent the escape of the power fuel when a reservoir is damaged.

To prevent escape from vehicles and transportable liquid reservoirs, in particular in the case of damaged or crashed vehicles, DE 43 39 772 A1 describes a safety apparatus in which the reservoir is filled in the interior with a cellular open-pore material, the cells of which take up the liquid in subquantities. Subdividing the liquid and using an appropriate material prevents the liquid from escaping if an accident or the like should occur in which the reservoir is opened. As open-pore cellular material, an open-pore foamed plastic or rubber is mentioned.

A disadvantage in this case is that a large part of the volume of the tank is lost, so that less transport capacity is available.

In addition, what are termed oil binders are known which have high specific surface area for binding petroleum or petroleum products if these should escape as a result of an accident or carelessness. Such binders are disclosed, for example, by DE 43 20 908 A1 or by DE 26 35 087 A1.

DE 94 00 792 T2 discloses, like DE 27 44 767 A1, apparatuses and methods for inertizing reservoirs, a physicochemical reaction not being possible between the inert gas and the substances stored in the reservoirs. The inert gas or protective gas is selected precisely so that a reaction with the stored substances, for example foods, does not take place. Retention of the stored substances in the substances to prevent escape is not disclosed.

DE 80 35 111 U1 relates to an apparatus for foaming substances stored in bunkers, for example readily ignitable substances such as brown coal. The risk of fire or explosion is reduced by a foam being placed into the bunker from the top in order to cover the surface of the bulk material situated in the bunker and if appropriate to stop any existing fires. It is not intended here that the substance stored in the bunker, for example the bulk material, reacts with the foam or a substance which is a constituent of the foam. Retention of the stored material in the substances to prevent escape is not disclosed.

CH 259 609, finally, relates to a foam useful for fire-extinguishing purposes in which the foam index may be increased by a higher alkyl sulfate. The alkyl sulfate can be admixed to the water immediately before use, or it can be kept dissolved in water ready for processing. No reaction between the substance to be extinguished and the foam or parts of the foam is disclosed which leads to a change in the extinguishing material. Retention in the foam of the substance to be extinguished to prevent escape is not disclosed.

All of the above publications therefore have the aim of filling the space above the material to be protected to prevent reaction between the material to be protected and another substance (for example oxygen in the case of oxidation or combustion).

JP-57-074215 and U.S. Pat. No. 5,531,290 relate to bringing the dangerous substance, here propellant fuel, by gelation, into a solid, outflow-preventing state. In the method, the propellant fuel becomes unusable and recycling, for example after accidental activation, is not possible. Also, the gelatinized fuel remains a fire hazard, since the flashpoint is not lowered.

The object of the invention is, in the case of a tank or reservoir filled with dangerous substances, to prevent escape, and suppress the risk of fire, without substantial reduction of the tank volume.

This object is achieved by a system for safeguarding dangerous substances such as propellant fuels in tank reservoirs in which the tank reservoir is connected to a feed unit in which are situated one or more materials which can be introduced into the tank reservoir and, by means of a physical reaction, transform the dangerous substance into an altered state preventing escape. “Feed unit” is taken to mean an apparatus which comprises the storage and dissolution of the substances for said reaction and which enables the introduction into the tank reservoir.

In the, or by means of the, feed unit, a chemical reaction can absolutely take place, the purpose of which, however, is essentially not that dangerous substance and materials react with one another chemically, i.e. with conversion of the dangerous substance for the purpose of binding the dangerous substance. For instance, e.g. the polyurethane foam used for binding, i.e. absorption of the propellant fuel, is formed in the unit chemically or at least the reaction necessary for formation of the foam is introduced by it. However, the unit can also take up the individual substances first separately and only combine them at the site of use, i.e. in the tank, where the actual reaction for formation of the foam takes place. The dangerous substance is bound, however, only by a purely physical absorption, like a sponge. Owing to the fact that the chemical composition of the dangerous substance is not changed, the absorbed substance can even be recycled, in contrast to the gelation known from the prior art.

By means of the feeding and introduction of the above-mentioned material, chemical and physical reactions are to proceed which minimize or eliminate the risk of ignition or escape. In principle, all air, land and water vehicles which carry dangerous goods for propulsion and/or transport can be safeguarded by such a system.

A physical reaction, for the purposes of the invention, is taken to mean that the dangerous substance is bound without using a chemical change of the dangerous substance, like, for example, in the case of purely physical absorption, sponge, classic oil binders. The term “binder”, for the purposes of the invention, is also to be taken to mean exclusively “physical binder”. If, in addition, chemical binding processes occur, this is also comprised in the invention.

The binding taking place in the tank has the advantage that binding takes place before outflow, so that at least a part of the tank structure remains usable and helps to retain the dangerous substance. In addition, in the case of physical binding, the weight usage of 1:10 to 1:60 of the binder per bound weight of dangerous substance is significantly lower than with chemical binding methods, e.g. gelation. This makes the method particularly attractive for weight-sensitive sectors, for example air travel, in which a high propellant fuel weight must be carried, in ratio to the total mass.

A suitable foam is, e.g., a PUR foam of diisocyanate and diol, as used, in particular, as installation foam. The dangerous substance is retained in the pores which are large in relation to the foam mass. Instead of the diisocyanate, the known replacement substances can be used.

A particularity here is that the absorbing binder is only formed by a chemical reaction immediately before use. As a result, initially compact space-saving materials can be carried, which only foam on use and thus form the required high contact surface area.

In a further aspect, it is provided that the binder, as soon as it is in contact with the dangerous substance, here propellant fuel, is simultaneously able to lower the flammability by means of a chemical reaction, that is not, as with known extinguishing foams, by simply covering. By means of the reaction, the flashpoint of the dangerous substance is increased, or this is made completely non-flammable. This can be achieved, for example, by adding dibromoneopentyl alcohol. It is particularly effective if on foam formation, the diisocyanate is replaced by dibromoneopentyl alcohol. Then the foam not only retains the propellant fuel in its numerous pores, but at the same time is exchanged with the propellant fuel over a particularly large finely divided contact surface, via which the bromine compounds of the foam can add to the hydrocarbon molecules of the propellant fuel in order to decrease the ignitability of the propellant fuel which is chemically modified in this manner. The flashpoint is therefore increased by physical binding and chemically.

Instead of dibromoneopentyl alcohol, diisocyanate and the like, similarly acting substances, e.g. powders, can also be added, by means of which even higher flashpoint elevations are possible.

Preferably, the tank reservoir is connected via a line to the feed unit, in which case the tank reservoir can be a closed propellant fuel tank, but also possibly an open propellant fuel tank.

A suitable feed unit is a one-part or multipart container which can be abruptly emptied by means of a high-efficiency pump system or by means of stored expanding pressurized gases, directly, or via tubes, into the dangerous substance tank. Suitable pressurized gases are, for example, carbon dioxide or nitrogen. By means of the propellant gas used, the PUR foam foams still better and is conducted into the tanks so as to decrease or avoid fire.

In an aircraft, tank reservoirs are provided in the wings and in the rear at various points. In this case, attention is to be paid in particular to the introducible materials being able to be fed as desired to the various tank reservoirs present in the aircraft.

As binders, use can also be made of particles of a polyolefin, for example polypropylene or polyethylene fibers, as are described, for example, in the publication DE 43 20 908 A1. As binders, use can also be made of particles of a hard polyurethane foam, this being used as a ground hard polyurethane foam which is treated on its surface with organosilanes.

Inert ceramic dusts, for example of finely ground calcium carbonate or silicon dioxide, can also be used as binder.

To make damage localization simpler, the binders can also be dyed, in particular so as to fluoresce. The dangerous good and/or the binder can also be admixed with catalysts which accelerate the reaction.

Exemplary embodiments of the invention shall be described hereinafter:

The figures, in detail, show:

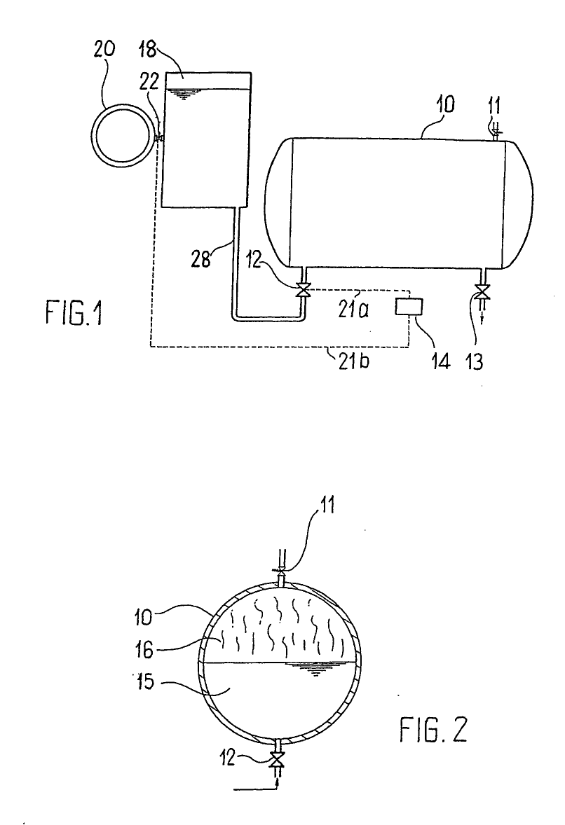

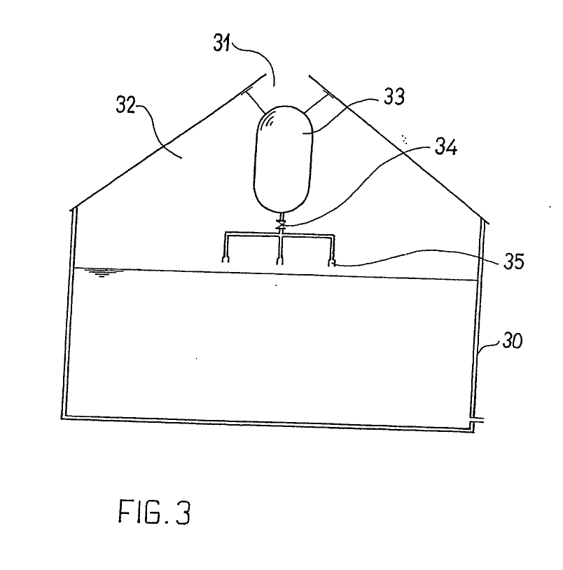

FIGS. 1 and 2, diagrammatically, an apparatus for eliminating risks of fire and escape in a tank system;

FIG. 3 an embodiment having an open tank vessel;

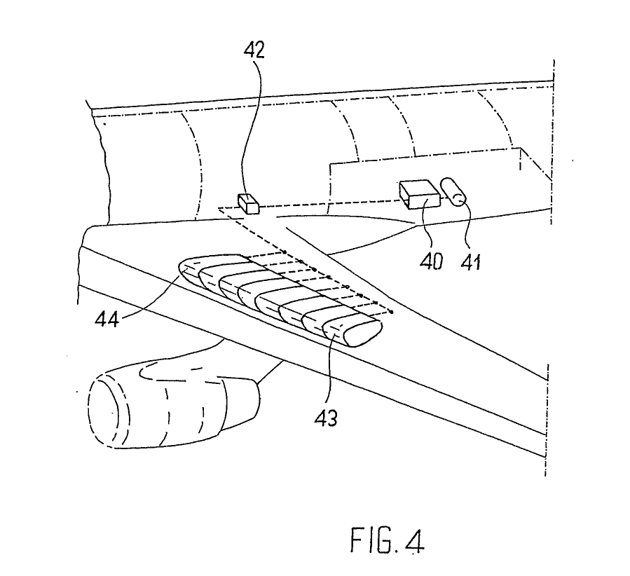

FIG. 4 an embodiment installed in an aircraft.

The hazard starting from readily ignitable power fuels is known. In order to achieve the rapid binding of liquid power fuels and thus a part of the fire risk, it is attempted to prevent the outflow of such power fuels and similar hydrocarbons. This reduces the fire risk and the risk of environmental contamination.

As exemplary embodiment, with reference to FIGS. 1 and 2, a stationary cylindrical tank reservoir 10 for storage of gasoline is described. The tank reservoir 10 is partially filled with gasoline 15. Above the liquid level there is situated vaporized gaseous gasoline 16. A safety valve 11 is provided since it opens as a function of the tank pressure in order to let off gaseous gasoline 16 in the event of overpressure is connected. In addition, a tank outlet 13 is present.

The safety device comprises a pressure vessel 18 to which a container 20 which is filled with CO₂ gas at 5 bar overpressure. Via an intermediate valve 22 which can be abruptly opened, the non-flammable CO₂ gas can be emptied into the vessel 18.

The safeguarding system further comprises a release switch 14, which, for example, can be coupled to an emergency button or a heat sensor (not shown). The release switch 14 is connected via two synchronously switched signal lines 21a and 21b to a release valve 12 at the lower region of the tank 10 and the further release valve 22 in the lateral region of the container 20.

On occurrence of an emergency situation, the release switch 14 is either actuated manually or triggered via a sensor. By opening the valves 22 and 12, the pressurized gas first flows from the contaianer 20 into the vessel 18 and introduces this via the line 28 and the valve 12 into the tank 10 for emptying.

In the tank 18, there is situated a material dispersed at high concentration in water which material reacts physically with the power fuel in the tank and solidifies the liquid. Suitable materials for this are oil binders of conventional type, for example based on polyolefin or polyurethane, or oil binders having inert inorganic substances, such as calcium carbonate or silicon dioxide flours. Such substances thicken the liquid in the container abruptly, so that outflow is avoided. Instead of the pressurized gas container, a pump (not shown) can also be installed into the line 28, which pump transports the material required for the reaction. In principle, it is also possible to depart from the dispersed form, by using a finely ground powder which is rapidly distributed in the dangerous good, and alters its viscosity and/or increases the ignition temperature.

The system in FIGS. 1 and 2 is not restricted to a stationary storage tank, but can in principle also be used for tank transport vehicles for road and water transport. The vessels 10 can consist of various materials.

In the case of use on tank ships, it is advantageous that a leak in the tank vessel does not lead to outflow of the propellant fuel when this fuel is mixed with the binders. The leak, in the case of appropriate size, can also be plugged.

FIG. 3 shows the system applied to an open tank vessel 30 for edible oils in tropical regions. Via the top opening 31, the volatile fraction of the oil can escape, the upper space 32 of the tank reservoir 30 being kept free from atmospheric oxygen. A pressure vessel 33 is filled with the inventive binders.

In the event of a hazard situation, a valve 34 can be actuated by radio control, so that the binder enters via distributor nozzles 35 and is distributed in the container contents. Solidification of the liquid oil occurs. The composition of the oil changes only slightly, since relatively small amounts of binders are required. The mixture remains accessible for human nutrition, e.g. by expression.

FIG. 4 shows diagrammatically a system configuration in an aircraft. It is of importance, here, in particular, in the case of a hazardous landing or on the airfield to ensure that, using on-board control, a binder is added to the propellant fuel still present in the aircraft tanks, so that these tanks can no longer empty. As propellant fuel, customary jet kerosene comes into consideration, which on contact with the inventive binder is restricted by a chemical reaction in its ignitability.

A substance to be introduced, here a two-component system, is situated as substance A or substance B in a container 40. In this case it can be a diisocyanate and a diol which are not combined until shortly before entry into the tank and polymerize to form a polyurethane foam. Via a propellant which is situated in a separate pressure vessel 41 the reaction mixture, here polyurethane foam, which is situated in the double container 40, can be forced into the tank, after a dividing wall has been ruptured. Then a polyurethane foam forms which is added to the propellant fuel in selected tanks 43, 44. In particular when diisocyanate is replaced by dibromoneopentyl alcohol or similar flashpoint-elevating substances, the propellant fuel reacts with this so as to reduce ignitability. By means of this binder modified by dibromoneopentyl alcohol and the like, the power fuel is physically bound and becomes of low flammability. Lump formation can also occur. The flashpoint is altered.

A foamed aggregate forms in which the propellant fuel is retained in the pores, the aggregate itself being so solid or so viscous that outflow is prevented. Catalysts and components which accelerate the solidification process can also be admixed to the dangerous good from the start.

By controlling via a control unit 42 of the material to the individual tanks (here denoted by 43, 44), only the individual tanks are charged which are still filled with propellant fuel, or in which the propellant fuel could not be discharged in flight.

The materials can also be arranged immediately adjacent to the tanks, so that the piping and control unit for switching the route of the piping is superfluous.

The pilot can check the readiness of the safety system via the system check. The decision on use of the safety system can be made by on-board personnel or personnel outside the aircraft if an appropriate remote control is installed, e.g. in the event of hijacking on the ground.

In emergency, the chemical substances can be fed to the aircraft tanks with the aid of pressure. The outflow of fuel is prevented, so that a fan-shaped fire below the aircraft cannot occur. Also, for example in the event of a parked aircraft, which is exposed to attack from the air, the tank contents can be neutralized by a feed actuated as a precaution. It is also advantageous that a binder elevates the flashpoint of the power fuel, so that here a further criterion for safety improvement is provided.

1. A system for safeguarding dangerous substances, such as propellant fuels, in tank reservoirs having a tank reservoir and a feed unit which is connected to the tank reservoir and in which materials which bind dangerous substances are situated, which materials can be introduced into the tank reservoir, characterized in that
tank reservoir and feed unit are connected to one another in such a manner, and the materials binding dangerous substances are selected in such a manner, that, on introduction of the materials
the dangerous substance in the tank reservoir can be physically retained in the materials, in particular by absorption and
by means of a chemical reaction, the dangerous substance in the tank reservoir can be transformed into an altered state which prevents ignition by elevating the flashpoint.

2. The system according to claim 1, characterized in that the tank vessel is a closed propellant fuel tank.

3. The system according to claim 1, characterized in that the tank vessel is an at least partially open collection reservoir.

4. The system according to claim 1, characterized in that the feed unit is a one-part or multipart container which can be abruptly emptied by means of a high-efficiency pump system or by means of stored expanding pressurized gasses.

5. The system according to claim 4, characterized in that the pressurized gas is carbon dioxide or nitrogen.

6. The system according to claim 1, characterized in that the system is installed in a land, air or water vehicle which carries with it a liquid dangerous good for propulsion and/or for transport, the materials which can be introduced being able to be fed as desired to the various tank reservoirs present in the vehicle.

7. The system according to claim 1, characterized in that the system is installed in a tank vehicle or a tank ship.

8. The system according to claim 1, characterized in that the material is a binder which is able to change the liquid, which is an aliphatic propellant fuel, chemically to decrease the ignitability of the liquid.

9. The system according to claim 1, characterized in that the binder consists of particles of polyolefin.

10. The system according to claim 1, characterized in that the binder consists of polypropylene or polyethylene fibers.

11. The system according to claim 1, characterized in that the binder consists of particles of a hard polyurethane foam.

12. The system according to claim 1, characterized in that, as binder, use is made of ground hard polyurethane foam which is treated on its surface with organosilanes.

13. The system according to claim 1, characterized in that, as binder, use is made of inert ceramic dusts.

14. The system according to claim 13, characterized in that, as binder, use is made of finely ground calcium carbonate or silicon dioxide.

15. The system according to claim 1, characterized in that the binder and/or the dangerous substance to be bound is admixed with catalysts which accelerate and/or optimize the reaction.

16. The system according to claim 1, characterized in that the binder is dyed, in particular, so as to fluoresce.

17. The system according to claim 1, characterized in that the binder is a foam, in particular PUR foam, in particular having diol and diisocyanate or dibromoneopentyl alcohol and the like.

18. The system according to claim 1, characterized in that the system can be activated manually and/or automatically.

19. The system according to claim 1, characterized in that the substances may also be located in immediate proximity in or at the tank container, so that the piping and control unit for switching the route of the piping is superfluous.
